(19) United States
(12) Patent Application Publication
(10) Pub. No.: US 2020/0327229 A1
(43) Pub. Date: Oct. 15, 2020

(54) METHOD, APPARATUS, ELECTRONIC DEVICE AND STORAGE MEDIUM FOR PROTECTING PRIVATE KEY OF DIGITAL WALLET

(71) Applicant: BEIJING KINGSOFT INTERNET SECURITY SOFTWARE CO., LTD., Beijing (CN)

(72) Inventor: Kangzong ZHANG, Beijing (CN)

(21) Appl. No.: 16/758,230

(22) PCT Filed: Oct. 15, 2018
(86) PCT No.: PCT/CN2018/110226

§ 371 Date: Apr. 22, 2020

(30) Foreign Application Priority Data
Feb. 12, 2018 (CN) 201810146008.7

(51) Int. Cl. G06F 21/56; G06Q 20/36; G06Q 20/38; G06F 21/60

(52) U.S. Cl. CPC G06F 21/566; G06Q 20/3674; G06F 21/602; G06F 21/568; G06Q 20/3829

(57) ABSTRACT

The embodiments of the present application provide a method, an apparatus, an electronic device and a storage medium for protecting a private key of a digital wallet, the method comprises: obtaining security detection information of an operating environment of a digital wallet as a first security detection information; obtaining security detection information for the digital wallet itself as a second security detection information; determining factors affecting the security of the private key of the digital wallet based on the first security detection information and/or the second security detection information; generating prompt information by using the factors and outputting the prompt information to prompt a user to process the factors affecting the security of the private key. By applying the embodiments of the present application, the user can learn the factors in the electronic device affecting the security of the private key of the digital wallet, so as that can process the factors to achieve the protection for the private key, ensuring the security of the assets in the digital wallet.

The present application claims the priority to a Chinese patent application No. 201810146008.7 filed with China National Intellectual Property Administration on Feb. 12, 2018 and entitled “Method, Apparatus, Electronic Device and Storage Medium for Protecting Private Key of Digital Wallet”, which is incorporated herein by reference in its entirety.

### TECHNICAL FIELD

The present application relates to the technical field of digital wallet, and in particular, to a method, an apparatus, an electronic device, and a storage medium for securing a private key of a digital wallet.

### BACKGROUND

With the development of technology, more and more users use a digital wallet to manage digital currencies (such as Bitcoin and Litecoin). The digital wallet is a wallet based on blockchain technology, and a private key is a unique credential for managing the digital currencies in the digital wallet.

However, there is no scheme for securing the private key of the digital wallet currently, so the private key is exposed to the risk of stealing at any time. When the private key is stolen, it causes the security risks that the digital currency could be stolen, thus the user's assets cannot be secured.

### SUMMARY

The purpose of the embodiments of the present application is to provide a method, an apparatus, an electronic device, and a storage medium for securing a private key of a digital wallet, which enables a user to knows factors in the electronic device affecting the security of the private key of the digital wallet, so as to process the factors to achieve the protection for the private key, ensuring the security of the assets in the digital wallet.

In a first aspect, an embodiment of the present application provides a method for securing the private key of the digital wallet, which may comprise:

obtaining security detection information for an operating environment of the digital wallet as a first security detection information;

obtaining security detection information for the digital wallet itself as a second security detection information;

determining factors affecting the security of the private key of the digital wallet based on the first security detection information and/or the second security detection information; and

generating prompt information by using the factors and outputting the prompt information to prompt a user to process the factors affecting the security of the private key.

Optionally, in an embodiment of the present application, the first security detection information comprises at least one of the following information for an electronic device in which the digital wallet is stored: virus detection information, vulnerability detection information, root permission detection information, and network transmission security detection information.

Optionally, when the obtained virus detection information indicates existence of a virus, the determined factors affecting the security of the private key comprise the existence of the virus;

when the obtained vulnerability detection information indicates existence of a vulnerability, the determined factors affecting the security of the private key comprise the existence of the vulnerability;

when the obtained root permission detection information indicates enabling of a root permission, the determined factors affecting the security of the private key comprise the enabling of the root permission; and

when the obtained network transmission security detection information indicates an insecure transmission network, the determined factors affecting the security of the private key comprise the insecure transmission network.

Optionally, in an embodiment of the present application, the second security detection information comprises at least one of the following information: detection information for read and write permission to a memory corresponding to the digital wallet, detection information for repackaging of an installation package of the digital wallet, and detection information for a private key storage mode of the digital wallet.

Optionally, when the obtained read and write permission detection information indicates that the read-write permission is enabled, the determined factors affecting the security of the private key comprise a factor that no read and write protection is enabled for the memory;

when the obtained repackaging detection information indicates a repackaged installation package, the determined factors affecting the security of the private key comprise a factor that the installation package of the digital wallet is not an original installation package; and

when the obtained detection information for the private key storage mode indicates that the private key is completely stored, the determined factors affecting the security of the private key comprise a factor that the private key is completely stored.

Optionally, in an embodiment of the present application, the method may further comprise detecting whether a security keyboard is installed in the electronic device in which the digital wallet is stored, and if a security keyboard is not installed in the electronic device, promoting the user to install a security keyboard.

Optionally, in an embodiment of the present application, the method may further comprise detecting whether the digital wallet is configured with an address whitelist, and if the digital wallet is not configured with an address whitelist, promoting the user to configure an address whitelist, wherein the address whitelist comprises secure transaction addresses and contract addresses.

In a second aspect, an embodiment of the present application also provides an apparatus for securing the private key of the digital wallet, which may comprise:

a first obtaining unit configured for obtaining security detection information for an operating environment of the digital wallet as a first security detection information;

a second obtaining unit configured for obtaining security detection information for the digital wallet itself as a second security detection information;

a determining unit configured for determining factors affecting the security of the private key of the digital wallet based on the first security detection information and/or the second security detection information; and

a prompting unit configured for generating prompt information by using the factors and outputting the prompt information to prompt a user to process the factors affecting the security of the private key.

Optionally, in the embodiment of the present application, the first security detection information obtained by the first obtaining unit comprises at least one of the following information for an electronic device in which the digital wallet is stored: virus detection information, vulnerability detection information, root permission detection information, and network transmission security detection information.

Optionally, when the virus detection information obtained by the first obtaining unit indicates existence of a virus, the factors affecting the security of the private key determined by the determining unit comprise the existence of the virus;

when the vulnerability detection information obtained by the first obtaining unit indicates existence of a vulnerability, the factors affecting the security of the private key determined by the determining unit comprise the existence of the vulnerability;

when the root permission detection information obtained by the first obtaining unit indicates enabling of a root permission, the factors affecting the security of the private key determined by the determining unit comprise the enabling of the root permission; and

when the network transmission security detection information obtained by the first obtaining unit indicates an insecure transmission network, the factors affecting the security of the private key determined by the determining unit comprise the insecure transmission network.

Optionally, in the embodiment of the present application, the second security detection information obtained by the second obtaining unit comprises at least one of the following information: detection information for read and write permission to a memory corresponding to the digital wallet, detection information for repackaging of an installation package of the digital wallet, and detection information for a private key storage mode of the digital wallet.

Optionally, when the read and write permission detection information obtained by the second obtaining unit indicates that the read-write permission is enabled, the factors affecting the private key security determined by the determining unit comprise a factor that no read and write protection is enabled for the memory;

when the repackaging detection information obtained by the second obtaining unit indicates a repackaged installation package, the factors affecting the security of the private key determined by the determining unit comprise a factor that the installation package of the digital wallet is not an original installation package; and

when the detection information for the private key storage mode obtained by the second obtaining unit indicates the private key is completely stored, the factors affecting the security of the private key determined by the determining unit comprise a factor that the private key is completely stored.

Optionally, in the embodiment of the present application, the apparatus may further comprise a first detection unit configured for detecting whether a security keyboard is installed in the electronic device in which the digital wallet is stored, and if a security keyboard is not installed in the electronic device, promoting the user to install a security keyboard.

Optionally, in the embodiment of the present application, the apparatus may further comprise a second detection unit configured for detecting whether the digital wallet is configured with an address whitelist, and if the digital wallet is not configured with an address whitelist, promoting the user to configure an address whitelist, wherein the address whitelist comprises secure transaction addresses and contract addresses.

In a third aspect, an embodiment of the present application also provides an electronic device comprising a processor, a communication interface, a memory, and a communication bus, wherein the processor, the communication interface, and the memory communicate with each other via the communication bus;

the memory is configured for storing computer programs; and

the processor is configured for executing the programs stored in the memory to implement steps according to any embodiment of the method for securing the private key of the digital wallet in the first aspect.

In a fourth aspect, an embodiment of the present application also provides a storage medium, with computer programs stored thereon, wherein the computer programs are executed by the processor to implement steps according to any embodiment of the method for securing the private key of the digital wallet in the first aspect.

In a fifth aspect, an embodiment of the present application also provides a computer program product, which is configured for implementing steps according to any embodiment of the method for securing the private key of the digital wallet in the first aspect when executed.

In the embodiments of the present application, a digital wallet can obtain the security detection information for the operating environment of the digital wallet as a first security detection information and can also obtain security detection information of the digital wallet itself as a second security detection information. Then, the factors affecting the security of the private key of the digital wallet can be determined based on the obtained first security detection information and/or the second security detection information. Prompt information can be generated by using the determined factors and outputted. In this way, a user can learn the factors in the electronic device affecting the security of the private key of the digital wallet through the prompt information, so as that can process the factors timely to achieve the protection for the private key, ensuring the security of the assets in the digital wallet.

### BRIEF DESCRIPTION OF THE DRAWINGS

In order to more clearly describe the technical solutions of the embodiments of the present application or of the prior art, drawings that need to be used in embodiments and the prior art will be briefly described below. Obviously, the drawings provided below are for only some embodiments of the present application; those skilled in the art can also obtain other drawings based on these drawings without any creative efforts.

FIG. 1 is a flow diagram of a method for securing a private key of a digital wallet according to an embodiment of the present application;

FIG. 2 is a schematic structural diagram of an apparatus for securing a private key of a digital wallet according to an embodiment of the present application;

FIG. 3 is a schematic structural diagram of an electronic device according to an embodiment of the present application.

### DETAILED DESCRIPTION OF THE INVENTION

In order to make the objectives, technical solutions, and advantages of the present application clearer and more understandable, the present application will be described in more detail below with reference to the appended drawings and embodiments. Obviously, the described embodiments are only some, and not all, of the embodiments of the present application. All other embodiments obtained based on the embodiments of the present application by those skilled in the art without any creative efforts fall into the scope of protection defined by the present application.

In order to solve the problem in the prior art of the threats that a private key of a digital wallet may be stolen, embodiments of the present application provide a method, an apparatus, an electronic device, and a storage medium for securing the private key of the digital wallet in views of security defense of the electronic device.

Firstly, a method for securing the private key of the digital wallet according to the embodiments of the present application will be described below.

It should be noted that the method for securing the private key of the digital wallet according to the embodiments of the present application is performed by a digital wallet client, which may also be referred to as a digital wallet. The digital wallet client is installed in an electronic device, and the electronic device includes, but is not limited to, a mobile phone and a tablet.

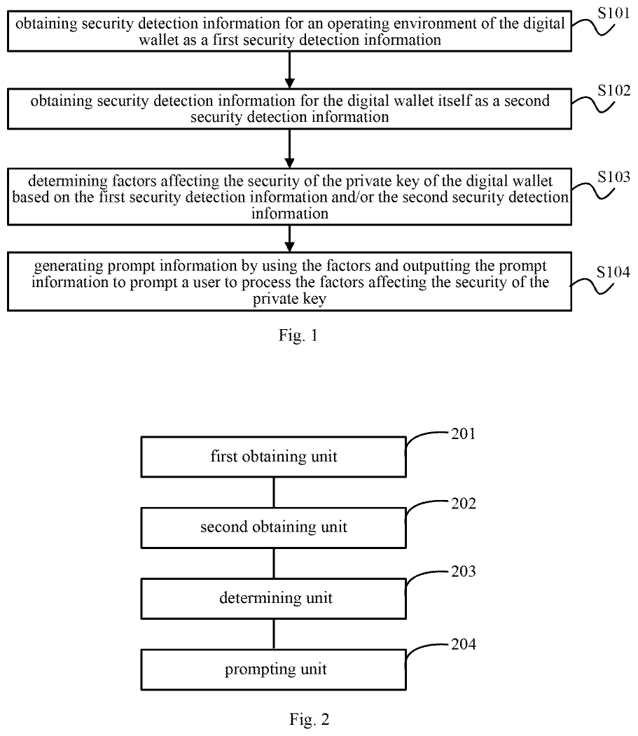

Referring to FIG. 1, a method for securing a private key of a digital wallet according to an embodiment of the present application may include the following steps:

Step 101: obtaining security detection information for an operating environment of the digital wallet as a first security detection information;

the operating environment of the digital wallet refers to an environment in which the program codes corresponding to the digital wallet are executed.

The applicant finds that the security of the operating environment of the digital wallet will affect the security of the private key of the digital wallet. When security risks exist in the operating environment of the digital wallet, it is easy for criminals to find a vulnerability from the security risks to steal the private key, which threats the security of the private key. Therefore, in order to ensure the security of the private key, security detection information for the operating environment of the digital wallet can be obtained in the embodiments of the present application.

Specifically, in one implementation, the security detection information for the operating environment of the digital wallet can be detected firstly by a security detection software installed in the electronic device in which the digital wallet is stored. Then, the digital wallet can request to obtain the security detection information detected by the security detection software and use the obtained security detection information as the first security detection information.

In another implementation, the security detection information for the operating environment of the digital wallet can be detected directly by the security detection plug-in in the digital wallet and used as the first security detection information, which is reasonable.

The obtained first security detection information may include, but not limited to, at least one of the following information for the electronic device in which the digital wallet is stored: virus detection information, vulnerability detection information, root permission detection information, and network transmission security detection information.

Furthermore, it indicates that security risks present in the operating environment of the digital wallet, if at least one of the following conditions is met: the virus detection information indicates existence of a virus; the vulnerability detection information indicates existence of a vulnerability; the root permission detection information indicates enabling of a root permission; and the network transmission security detection information indicates an insecure transmission network.

The vulnerability includes, but not limited to, operating system vulnerabilities and application vulnerabilities in the electronic device. Furthermore, the root permission is the highest permission of the system, after which is enabled, any files in the system (including system files) can be added, deleted, modified, and checked.

Step 102: obtaining security detection information for the digital wallet itself as a second security detection information.

The applicant also finds that those skilled in the art often ignore that the digital wallet itself will also affect the security of the private key of the digital wallet. For example, if the installation package corresponding to the digital wallet is a repackaged installation package, rather than an original installation package, malicious codes for stealing the private key may be written in the installation package. Therefore, in the embodiments of the present application, the security detection information for the digital wallet itself can also be obtained and taken as the second security detection information in order to ensure the security of the private key.

The obtained second security detection information may include, but not limited to, at least one of the following information: detection information for read and write permission to the memory corresponding to the digital wallet, detection information for repackaging of the installation package of the digital wallet, and detection information for a private key storage mode of the digital wallet.

The memory corresponding to the digital wallet refers to a storage space that is specified during digital wallet installation for storing data related to the digital wallet. Since a user may store the private key of the digital wallet in the memory corresponding to the digital wallet, the private key has risks of being stolen and tampered when detection information for the read and write permission to the memory indicates that the permission is a read-write permission.

Furthermore, when the detection information for the private key storage mode of the digital wallet indicates the private key is completely stored, it is easier for the criminals to steal the completely-stored private key, that is, the private key also has risks of being stolen.

Step 103: determining factors affecting the security of the private key of the digital wallet based on the first security detection information and/or the second security detection information.

After obtaining the first security detection information and the second security detection information, those skilled in the art can determine the factors affecting the security of the digital wallet based on the first security detection information and/or the second security detection information according to specific needs.

It should be understood that, for the first security detection information, when the obtained virus detection information indicates existence of a virus, the determined factors affecting the security of the private key may include the existence of the virus; when the obtained vulnerability detection information indicates existence of a vulnerability, the determined factors affecting the security of the private key may include the existence of the vulnerability; when the obtained root permission detection information indicates enabling of a root permission, the determined factors affecting the security of the private key may include enabling of the root permission; and when the obtained network transmission security detection information indicates an insecure transmission network, the determined factors affecting the security of the private key may include an indication that the electronic device is located in an insecure transmission network.

For the second security detection information, when the obtained read and write permission detection information indicates that the read-write permission is enabled, the determined factors affecting the security of the private key may include a factor that no read and write protection is enabled for the memory; when the obtained repackaging detection information indicates a repackaged installation package, the determined factors affecting the security of the private key may include a factor that the installation package of the digital wallet is not the original installation package; when the obtained detection information for the private key storage mode indicates the private key is completely stored, the determined factors affecting the security of the private key may include a factor that the private key is completely stored.

Step 104: generating prompt information by using the factors and outputting the prompt information to prompt a user to process the factors affecting the security of the private key.

After determining the factors affecting the security of the private key, prompt information can be generated by using the determined factors and outputted, in order to prompt the user to process the factors affecting the security of the private key.

For example, when the determined factors affecting the security of the private key comprise the existence of the virus and the indication that the installation package of the digital wallet is not the original installation package, the following prompt information is generated: a virus exists, please kill the virus; the installation package of the digital wallet is not the original installation package, it is recommended to use the original installation package to install the digital wallet.

Furthermore, when the determined factors affecting the security of the private key also comprise the existence of the vulnerability, the enabling of the root permission, an insecure transmission network, a factor that no read and write protection is enabled for the memory, and a factor that the private key is completely stored, the following prompt information is generated sequentially: a vulnerability threat exists, please fix the vulnerability; it is recommended to disable the root permission; the current network is an insecure transmission network, it is recommended to use a secure transmission network; it is recommended to enable the read-write protections for the memory; it is recommended to enable a secure storage mode for the distributed storage of the private key.

In the embodiments of the present application, the digital wallet can obtain the security detection information for the operating environment of the digital wallet as the first security detection information and can also obtain security detection information thereof as the second security detection information. Then, the factors affecting the security of the private key of the digital wallet can be determined based on the obtained first security detection information and/or second security detection information. The prompt information can be generated by using the determined factors and outputted. In this way, the user can learn the factors in the electronic device affecting the security of the private key of the digital wallet through the prompt information, so as that can process the factors to achieve the protection for the private key, ensuring the security of the assets in the digital wallet.

It should be understood that, for providing a more secure digital wallet to the user, whether a security keyboard is installed in the electronic device, in which the digital wallet is stored, can also be detected to further ensure the security of the private key in the embodiments of the present application, and if a security keyboard is not installed in the electronic device, the user is prompted to install a security keyboard. After the security keyboard is installed, the private key during input can not be stolen, further ensuring the security of the private key.

The security keyboard is a virtual keyboard that displays on the screen of the electronic device, of which input is through mouse clicks and input key position may randomly change.

Furthermore, whether the digital wallet is configured with an address whitelist can also be detected to further ensure the security of the private key, and if the digital wallet is not configured with an address whitelist, the user is prompted to configure an address whitelist. The address whitelist comprises secure transaction addresses and contract addresses. When the transaction addresses and contract addresses during transaction do not match addresses in the address whitelist, the transaction addresses and contract addresses during transaction are addresses with security threats, and at this time, a danger warning can prompt to the user for a cautious transaction, so as that ensures the security of assets in digital wallets.

Of course, whether the digital wallet is configured with an address blacklist can also be detected, and if the digital wallet is not configured with an address blacklist, the user is prompted to configured an address blacklist with the dangerous transaction addresses and contract addresses, which is also reasonable.

With respect to the embodiments of the method described above, an embodiment of the present application further provides an apparatus for securing a private key of a digital wallet, referred to FIG. 2, which may comprise:

a first obtaining unit 201 configured for obtaining security detection information for an operating environment of the digital wallet as a first security detection information;

a second obtaining unit 202 configured for obtaining security detection information for the digital wallet itself as a second security detection information;

a determining unit 203 configured for determining factors affecting the security of the private key of the digital wallet based on the first security detection information and/or the second security detection information; and

a prompting unit 204 configured for generating prompt information by using the factors and outputting the prompt information to prompt a user to process the factors affecting the security of the private key.

With the apparatus according to the embodiments of the present application, the digital wallet can obtain the security detection information for the operating environment of the digital wallet as the first security detection information and can also obtain security detection information thereof as the second security detection information. Then, the factors affecting the security of the private key of the digital wallet can be determined based on the obtained first security detection information and/or second security detection information. Prompt information can be generated by using the determined factors and outputted. In this way, the user can learn the factors in the electronic device affecting the security of the private key of the digital wallet through the prompt information, so as that can process the factors timely to achieve the protection for the private key, ensuring the security of the assets in the digital wallet.

Optionally, the first security detection information obtained by the first obtaining unit comprises at least one of the following information for an electronic device in which the digital wallet is stored: virus detection information, vulnerability detection information, root permission detection information, and network transmission security detection information.

Optionally, when the virus detection information obtained by the first obtaining unit 201 indicates existence of a virus, the factors affecting the security of the private key determined by the determining unit 203 comprise the existence of the virus;

when the vulnerability detection information obtained by the first obtaining unit 201 indicates existence of a vulnerability, the factors affecting the security of the private key determined by the determining unit 203 comprise the existence of the vulnerability;

when the root permission detection information obtained by the first obtaining unit 201 indicates enabling of a root permission, the factors affecting the security of the private key determined by the determining unit 203 comprise the enabling of the root permission; and

when the network transmission security detection information obtained by the first obtaining unit 201 indicates an insecure transmission network, the factors affecting the security of the private key determined by the determining unit 203 comprise the insecure transmission network.

Optionally, the second security detection information obtained by the second obtaining unit 202 comprises at least one of the following information: detection information for read and write permission to a memory corresponding to the digital wallet, detection information for repackaging of an installation package of the digital wallet, and detection information for a private key storage mode of the digital wallet.

Optionally, when the read and write permission detection information obtained by the second obtaining unit 202 indicates that the read-write permission is enabled, the factors affecting the private key security determined by the determining unit 203 comprise a factor that no read and write protection is enabled for the memory;

when the repackaging detection information obtained by the second obtaining unit 202 indicates a repackaged installation package, the factors affecting the security of the private key determined by the determining unit 203 comprise a factor that the installation package of the digital wallet is not an original installation package; and

when the detection information for the private key storage mode obtained by the second obtaining unit 202 indicates the private key is completely stored, the factors affecting the security of the private key determined by the determining unit 203 comprise a factor that the private key is completely stored.

Optionally, in the embodiments of the present application, the apparatus may further comprise a first detection unit configured for detecting whether a security keyboard is installed in the electronic device in which the digital wallet is stored, and if a security keyboard is not installed in the electronic device, promoting the user to install a security keyboard.

Optionally, in the embodiments of the present application, the apparatus further comprises a second detection unit configured for detecting whether the digital wallet is configured with an address whitelist, and if the digital wallet is not configured with an address whitelist, promoting the user to configure an address whitelist, wherein the address whitelist comprises secure transaction addresses and contract addresses.

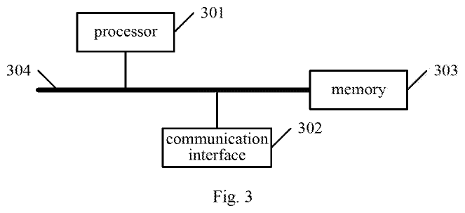

With respect to the method embodiment described above, an embodiment of the present application further provides an electronic device, referred to FIG. 3, which comprises a processor 301, a communication interface 302, a memory 303, and a communication bus 304, between which the processor 301, the interface 302, and the memory 303 communicate with each other via the communication bus 304;

the memory 303 is configured for storing computer programs; and

the processor 301 is configured for executing the programs stored in the memory 303 to implement steps according to any embodiment of the method for securing the private key of the digital wallet.

The electronic device according to the embodiments of the present application can obtain security detection information for the operating environment of the digital wallet installed in the electronic device as a first security detection information and can also obtain security detection information for the digital wallet itself as a second security detection information. Then, factors affecting the security of the private key of the digital wallet can be determined based on the obtained first security detection information and/or second security detection information. Prompt information can be generated by using the determined factors and outputted. In this way, the user can learn the factors in the electronic device affecting the security of the private key of the digital wallet through the prompt information, so as that can process the factors timely to achieve the protection for the private key, ensuring the security of the assets in the digital wallet.

The communication bus in the electronic device may be a Peripheral Component Interconnect (PCI) bus or an Extended Industry Standard Architecture (EISA) bus, etc. The communication bus can be divided into an address bus, a data bus, a control bus, etc. For ease of representation, only one thick line is depicted in the figure, but it does not mean that there is only one bus or one type of bus.

The communication interface is configured for communicating between the electronic device mentioned above and other devices.

The memory may comprise a Random Access Memory (RAM) and also a Non-Volatile Memory (NVM), for example, at least one disk memory. Optionally, the memory may also be at least one storage device located far away from the processor.

The processor may be a general-purpose processor comprising a Central Processing (CPU), a Network Processor (NP), etc.; the processor may also be a Digital Signal Processor (DSP), an Application Specific Integrated Circuit (ASIC), a Field-Programmable Gate Array (FPGA) or other programmable logic devices, discrete gate or transistor logic devices, and discrete hardware components.

With respect to the embodiments of the method described above, an embodiment of the present application further provide a storage medium that is a computer-readable storage medium, and the storage medium stores the computer programs which are executed by the processor to implement steps according to any embodiment of the method for securing the private key of the digital wallet.

After the computer programs stored in the storage medium according to the embodiments of the present application are executed by the processor of the electronic device, security detection information for the operating environment of the digital wallet installed in the electronic device can be obtained as a first security detection information, and security detection information for the digital wallet itself can also be obtained as a second security detection information. Then, the factors affecting the security of the private key of the digital wallet can be determined based on the obtained first security detection information and/or second security detection information. Prompt information can be generated by using the determined factors and outputted. In this way, the user can learn the factors in the electronic device affecting the security of the private key of the digital wallet through the prompt information, so as that can process the factors timely to achieve the protection for the private key, ensuring the security of the assets in the digital wallet.

With respect to the embodiments of the method described above, an embodiment of the present application further provides a computer program product, which is configured for implementing steps according to any embodiment of the method for securing the private key of the digital wallet in a first aspect when executed.

After the computer program product is executed by the processor of the electronic device, security detection information for the operating environment of the digital wallet installed in the electronic device can be obtained as a first security detection information, and security detection information for the digital wallet itself can also be obtained as a second security detection information. Then, the factors affecting the security of the private key of the digital wallet can be determined based on the obtained first security detection information and/or second security detection information. Prompt information can be generated by using the determined factors and outputted. In this way, the user can learn the factors in the electronic device affecting the security of the private key of the digital wallet through the prompt information, so as that can process the factors timely to achieve the protection for the private key, ensuring the security of the assets in the digital wallet.

It should be noted that the relationship terms use here, such as “first,” “second,” and the like are only used to distinguish one entity or operation from another entity or operation, but do not necessarily require or imply that there is actual relationship or order between these entities or operations. Moreover, the terms “include,” “comprise,” or any variants thereof are intended to cover a non-exclusive inclusion, such that processes, methods, articles, or devices, including a series of elements, include not only those elements that have been listed, but also other elements that have not specifically been listed or the elements intrinsic to these processes, methods, articles, or devices. Without further limitations, elements limited by the wording “comprise(s) a/an . . . ” do not exclude additional identical elements in the processes, methods, articles, or devices, including the listed elements.

All of the embodiments in the description are described in a correlated manner, and identical or similar parts in various embodiments can refer to one another. In addition, the description for each embodiment focuses on the differences from other embodiments. In particular, the embodiments of the apparatus, electronic device, storage medium and computer program product are described briefly, since they are substantially similar to the embodiment of the method, and the related contents can refer to the description of the embodiment of the method.

The descriptions mentioned-above are only preferred embodiments of the present application, and are not intended to limit the scope of the present application. Any modification, equivalent, or improvement within the spirit and principle of this application are included within the scope of this application.

1. A method for securing a private key of a digital wallet, comprising:
obtaining security detection information for an operating environment of the digital wallet as a first security detection information;
obtaining security detection information for the digital wallet itself as a second security detection information;
determining factors affecting the security of the private key of the digital wallet based on the first security detection information and/or the second security detection information; and
generating prompt information by using the factors and outputting the prompt information to prompt a user to process the factors affecting the security of the private key.

2. The method according to claim 1, wherein, the first security detection information comprises at least one of the following information for an electronic device in which the digital wallet is stored: virus detection information, vulnerability detection information, root permission detection information, and network transmission security detection information.

3. The method according to claim 2, wherein,
when the obtained virus detection information indicates existence of a virus, the determined factors affecting the security of the private key comprise the existence of the virus;
when the obtained vulnerability detection information indicates existence of a vulnerability, the determined factors affecting the security of the private key comprise the existence of the vulnerability;
when the obtained root permission detection information indicates enabling of a root permission, the determined factors affecting the security of the private key comprise the enabling of the root permission; and
when the obtained network transmission security detection information indicates an insecure transmission network, the determined factors affecting the security of the private key comprise the insecure transmission network.

4. The method according to claim 1, wherein, the second security detection information comprises at least one of the following information: detection information for read and write permission to a memory corresponding to the digital wallet, detection information for repackaging of an installation package of the digital wallet, and detection information for a private key storage mode of the digital wallet.

5. The method according to claim 4, wherein,
when the obtained read and write permission detection information indicates that the read-write permission is enabled, the determined factors affecting the security of the private key comprise a factor that no read and write protection is enabled for the memory;
when the obtained repackaging detection information indicates a repackaged installation package, the determined factors affecting the security of the private key comprise a factor that the installation package of the digital wallet is not an original installation package; and
when the obtained detection information for the private key storage mode indicates that the private key is completely stored, the determined factors affecting the security of the private key comprise a factor that the private key is completely stored.

6. The method according to claim 1, further comprising: detecting whether a security keyboard is installed in the electronic device in which the digital wallet is stored, and if a security keyboard is not installed in the electronic device, promoting the user to install a security keyboard.

7. The method according to claim 1, further comprising: detecting whether the digital wallet is configured with an address whitelist, and if the digital wallet is not configured with an address whitelist, promoting the user to configure an address whitelist, wherein the address whitelist comprises secure transaction addresses and contract addresses.

8-14. (canceled)

15. An electronic device, comprising: a processor, a communication interface, a memory, and a communication bus; wherein the processor, the communication interface, and the memory communicate with each other via the communication bus;
the memory is configured for storing computer programs; and
the processor is configured for executing the programs stored in the memory to implement a method for securing a private key of a digital wallet, wherein the method comprises:
obtaining security detection information for an operating environment of the digital wallet as a first security detection information;
obtaining security detection information for the digital wallet itself as a second security detection information;
determining factors affecting the security of the private key of the digital wallet based on the first security detection information and/or the second security detection information; and
generating prompt information by using the factors and outputting the prompt information to prompt a user to process the factors affecting the security of the private key.

16. A non-transitory computer readable storage medium with computer programs stored thereon, wherein the computer programs are executed by a processor to implement steps of the method according to claim 1.

17. (canceled)

18. The electronic device according to claim 15, wherein, the first security detection information comprises at least one of the following information for an electronic device in which the digital wallet is stored: virus detection information, vulnerability detection information, root permission detection information, and network transmission security detection information.

19. The electronic device according to claim 18, wherein,
when the obtained virus detection information indicates existence of a virus, the determined factors affecting the security of the private key comprise the existence of the virus;
when the obtained vulnerability detection information indicates existence of a vulnerability, the determined factors affecting the security of the private key comprise the existence of the vulnerability;
when the obtained root permission detection information indicates enabling of a root permission, the determined factors affecting the security of the private key comprise the enabling of the root permission; and
when the obtained network transmission security detection information indicates an insecure transmission network, the determined factors affecting the security of the private key comprise the insecure transmission network.

20. The electronic device according to claim 15, wherein, the second security detection information comprises at least one of the following information: detection information for read and write permission to a memory corresponding to the digital wallet, detection information for repackaging of an installation package of the digital wallet, and detection information for a private key storage mode of the digital wallet.

21. The electronic device according to claim 20, wherein,
when the obtained read and write permission detection information indicates that the read-write permission is enabled, the determined factors affecting the security of the private key comprise a factor that no read and write protection is enabled for the memory;
when the obtained repackaging detection information indicates a repackaged installation package, the determined factors affecting the security of the private key comprise a factor that the installation package of the digital wallet is not an original installation package; and
when the obtained detection information for the private key storage mode indicates that the private key is completely stored, the determined factors affecting the security of the private key comprise a factor that the private key is completely stored.

22. The electronic device according to claim 15, wherein the method further comprises: detecting whether a security keyboard is installed in the electronic device in which the digital wallet is stored, and if a security keyboard is not installed in the electronic device, promoting the user to install a security keyboard.

23. The electronic device according to claim 15, wherein the method further comprises: detecting whether the digital wallet is configured with an address whitelist, and if the digital wallet is not configured with an address whitelist, promoting the user to configure an address whitelist, wherein the address whitelist comprises secure transaction addresses and contract addresses.
